(19) United States
(12) Patent Application Publication
(10) Pub. No.: US 2008/0256591 A1
(43) Pub. Date: Oct. 16, 2008

(54) Virtual webcam and method thereof

(75) Inventor: Hong-Yuan Li, Hangzhou City (CN)

Correspondence Address: BACON & THOMAS, PLLC, 625 SLATERS LANE, FOURTH FLOOR, ALEXANDRIA, VA, 22314-1176, US

(73) Assignee: ArcSoft, Inc., Fremont, CA (US)

(21) Appl. No.: 11/783,455

(22) Filed: Apr. 10, 2007

(51) Int. Cl. H04N 7/16

(52) U.S. Cl. 725/136

(57) ABSTRACT

A virtual webcam applied in a computer includes a user interface application module for exchanging information between a computer and a user, so that a user can set parameter and format of a video signal source, select a special effect for a video signal, and select an output parameter and a format of a virtual webcam; a data processing module for processing special effects for the video signals transmitted from different signal sources and transmitting the video signals to the virtual webcam driver module; and a virtual webcam driver module for outputting the video signals according to the output format of a general webcam, so as to enable the outputted video signals to be used by a chatting tool and then shared by an opposite party over the Internet through the chatting tool.

### FIELD OF THE INVENTION

The present invention relates to a virtual webcam, and more particularly to a method enabling a computer user to play a video or graphic file stored in the computer by using a virtual webcam for an opposite party over the internet through the chatting tool during an online video chatting.

### BACKGROUND OF THE INVENTION

In recent years, digital imaging technology advances, and thus various different digital imaging devices (such as digital cameras, digital camcorders and webcam, etc) are developed rapidly, not only providing increasingly higher imaging quality and producing increasingly smaller products, but also lowering the price significantly. Therefore, digital imaging devices become more popular day after day, and thus are applied extensively in various different computer devices (such as digital personal assistants and notebook computers, etc) and communication devices (such as mobile phones and video phones, etc), so that when users connect with each other through computers or communication devices for online chatting, the real-time images captured by these digital imaging devices can be transmitted as well. In an online chatting process, any party can receive the real-time images and see the facial expressions of the opposite party, so as to enhance the real and warming feeling of chatting.

In a chatting process, facial expressions generally play a very important role, not only reflecting a person's attitude, but also expressing the person's true emotion through the expressions of laughter, anger, sorrow and joy. Therefore, online video chatting can be conducted through the online connection of a computer or a communication device, and such online video chatting is more attractive to users than conventional network non-video chatting. However, when existing computers or communication devices are used for conducting online video chatting, the images captured by the webcam include a user's face and other images irrelevant to the user's facial expressions such the images of the user's environment background and body. If the user's environment background is very private (such as a bedroom) or the user's clothing is not decent (such as wearing underwear only), then it will be inappropriate to conduct an online video chatting through the computer or communication device. In addition, the real-time images captured by a webcam occupy a larger data volume when an online video chatting is conducted, and thus a wider bandwidth is required for the network transmissions. As to users who carry out an online video chatting in a narrow bandwidth network. The video images usually cannot be transmitted real-time to the opposite party, and a delay of video transmission may occur. As a result, both parties cannot enjoy the true feeling and fun of online chatting.

Since the present network chatting tools such as Yahoo Messenger and MSN Messenger transmit video streams in a RGB format with the resolution of 320×240 (or 160×120) per frame, these chatting tools have no specific requirements on frame rate, but the general tools usually require a frame rate of 15 frames/sec or 30 frames/sec. On the other hand, the present webcams manufactured by major manufacturers come with different output formats of video signals. For instance, the Philips SPC 900 NC webcam has an image transmission format of 1420, IYUV or YUV2, and the resolution of each frame size is 160×120, 176×144, 320×240, 352×288 or 640×480, but the Microsoft VX6000 webcam has an image transmission format of RGB24 or 1420, and the resolution of each frame size is 160×120, 176×144, 320×240, 352×288, 640×480, 800×600, 1024×768 or 1280×1024. As a result, users may have an incompatible issue with the image transmission format of the webcams due to the limitation of computer performance and the difference of computer hardware configurations, when the users are using these chatting tools for online video chatting. Sometimes, the chatting tools cannot use the real-time video images captured by the real webcam normally or cannot transmit the video image to the opposite party real-time, so that if users conduct online video chatting, and many computer users have not installed a real webcam yet, users will have to face the monotonous video screen without any image, and thus it will greatly reduce the fun of instant chatting.

Therefore, it is an important objective for online video system designers and manufacturers to find a way of designing a virtual webcam, such that when users conduct an online video chatting regardless of whether or not they have installed a real webcam, the users can play a video or graphic file stored in a computer for the opposite party through the virtual webcam, or provide a video image captured by a real webcam to the opposite party through a chatting tool, after going through a special effect processing by the virtual webcam. The invention can avoid disclosing a user's personal chatting location or revealing the user's personal life and privacy.

### SUMMARY OF THE INVENTION

In view of the incompatible image transmission format of a conventional webcam with a chatting tool, and the issue of disclosing a user's personal chatting location or revealing the user's personal life and privacy in accordance with the prior art, the inventor of the present invention based on years of experience in the related industry to conduct extensive researches and experiments, and finally developed a virtual webcam and its method to overcome the foregoing shortcomings of the prior art.

Therefore, it is a primary objective of the present invention to provide a virtual webcam and a method thereof, and the virtual webcam is applied in a computer and comprises three main modules: a user interface application module (at an outer layer), a data processing module (at a middle layer) and a virtual webcam driver module (at an inner layer), wherein the user interface application module is a man-machine interactive interface provided for exchanging information between a computer and a user, so that the user can use the user interface application module for setting a parameter and a format of a video signal source, selecting a special effect for a video signal, and selecting output parameter and format of a virtual webcam; the data processing module is provided for processing different special effects for the video signals transmitted from various different signal sources, and transmitting the processed video signals to the virtual webcam driver module; the virtual webcam driver module is a terminate and stay resident program provided for outputting the received video signals according to the output format of a general webcam, and the video signals can be used by a chatting tool (such as Yahoo Messenger) and its contents can be shared by an opposite party over the Internet.

Another objective of the present invention is to provide a virtual webcam and a method thereof, such that a computer user who installs a real webcam regardless of whether or not the image transmission format of the webcam is compatible with the chatting tool can convert the video images captured by the real webcam real-time into an image transmission format acceptable by the chatting tool, and the processed special effect of the virtual webcam can be provided for an opposite party through the chatting tool, so as to effectively avoid disclosing a user's personal chatting location or revealing the user's personal life and privacy.

A further objective of the present invention is to provide a virtual webcam and a method thereof, such that a computer user who has not installed a real webcam can play a video or graphic file stored in a computer by the virtual webcam for an opposite party through the chatting tool during an online video chatting, so that both parties can share the video or graphic file on a video screen, and thus users no longer have to face a monotonous video screen without any image, and the invention can give more fun to instant chatting greatly.

To make it easier for our examiner to understand the objective, technical characteristics and effects of the present invention, preferred embodiments will be described with accompanying drawings as follows:

### BRIEF DESCRIPTION OF THE DRAWINGS

FIG. 1 is a schematic block diagram of a preferred embodiment of a virtual webcam in accordance with the present invention;

FIG. 2 is a flow chart of a user interface application module in accordance with the present invention;

FIG. 3 is a flow chart of a data processing module in accordance with the present invention; and

FIG. 4 is a flow chart of a virtual webcam driver module in accordance with the present invention.

### DETAILED DESCRIPTION OF THE PREFERRED EMBODIMENTS

The incompatibility issue between the real webcam and the network chatting tool is generally caused by the different formats of a frame size or a frame rate of a video stream captured by the real webcam, and thus these formats will not comply with the requirements of a network chatting tool. In view of the foregoing shortcomings, the present inventions provides a virtual webcam for converting the format of a video transmission of a real webcam into a format acceptable by the network chatting tool, so that the chatting tool can use the video stream captured by the real webcam normally. For computer users who have not installed a webcam, the present invention can play a video or graphic file stored in a computer to an opposite party through the chatting tool by the virtual webcam during a network chatting, so as to share the video resources.

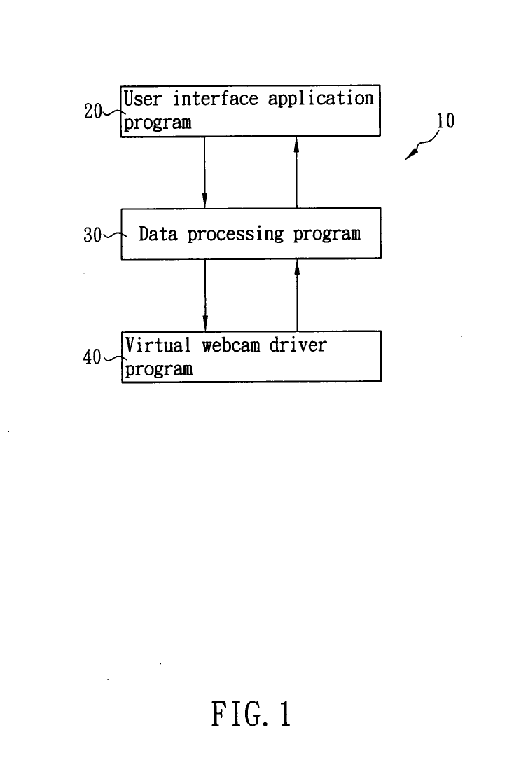

Referring to FIG. 1 for a preferred embodiment of the present invention, the virtual webcam 10 of the invention includes the following three main modules:
(1) A user interface application module 20 at an outer layer is a man-machine interactive interface provided for completing an information exchange between a computer and a user, such that the user can achieve the following functions through the user interface application module 20:
   (a) Set up the parameter and format of a video signal source, wherein the parameter of the video signal source is used for specifying a desired video signal source including a graphic file, a video file, a video captured by a real webcam and a video data of a DV device. For instance, the format of a video signal source could be a frame size of 640×480, and a video signal with a frame rate of 30 frames/sec in the YUV format.
   (b) Select a setup parameter for the special effect processing of a video signal by specifying the video signal to perform the designated special effect such as a fun-house mirror, a cartoon style, or a mosaic effect.
   (c) Select the output parameter and format of the virtual webcam, such as a frame size of 320×240, and a video signal with a frame rate of 25 frames/sec in the RGB format.
   (d) Terminate the application program of the virtual webcam and exit or terminate the user interface application module 20.
(2) A data processing module 30 at a middle layer is provided for performing a special effect processing for a video signal transmitted from various different signal sources as well as executing different set special effects and transmitting the video signal processed by the special effect processing to a virtual webcam driver module 40 at an inner layer.
(3) The virtual webcam driver module 40 at an inner layer is a terminate and stay resident program provided for outputting a received video signal according to an output format of a general webcam to comply with the format requirement of a chatting tool (such as Yahoo Messenger) and facilitate the use of a chatting tool (such as Yahoo Messenger) and share the content of video signals with an opposite party over the Internet.

Although a computer cannot retrieve the instant image through the virtual webcam 10 of the present invention, the virtual webcam 10 allows a user to play a video or graphic file stored in the computer through a chatting tool to an opposite party during a network chatting, and share video resources with the opposite party. Further, the virtual webcam 10 can also play video signals transmitted from the same video source simultaneously in several windows for the use of several chatting tools and allow several parties to share video resources during a network chatting.

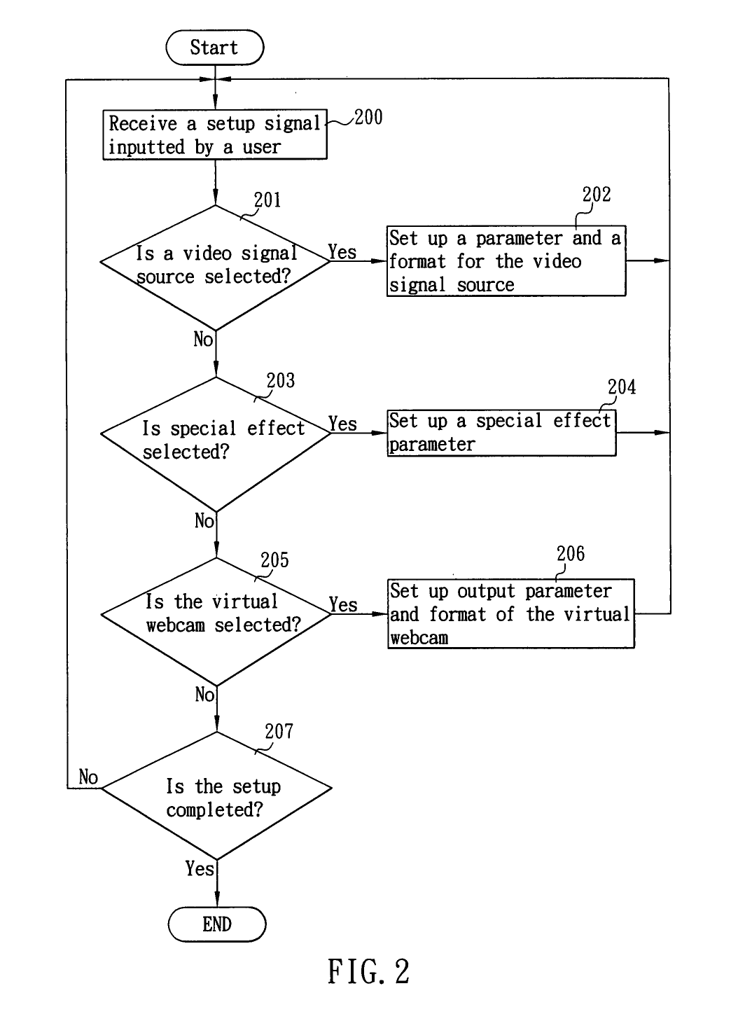

Referring to FIG. 2 for a user interface application module 20 of a virtual webcam 10 in accordance with this embodiment, the user interface application module 20 performs a processing procedure comprising the steps of:

Step (200): receiving a setup signal inputted by an input device (such as a keyboard) through a user's computer;

Step (201): determining whether or not the setup signal selects to set up a video signal source; if yes, then go to Step (202), or else go to Step (203);

Step (202): setting up parameter and format for the video signal source, and returning to Step (200);

Step (203): determining whether or not the setup signal selects to set up a video signal to perform a special effect processing; if yes, then go to Step (204); or else go to Step (205);

Step (204): setting up a special effect processing for the video signal, and returning to Step (200);

Step (205): determining whether or not the setup signal selects to set up the virtual webcam 10; if yes, then go to Step (206), or else go to Step (207);

Step (206): setting up output parameter and format of the virtual webcam 10, and returning to Step (200); and

Step (207): determining whether or not the user confirms the completion of the setup; if yes, then end the processing procedure of the user interface application module 20; or else return to Step (200) and continues the foregoing procedure.

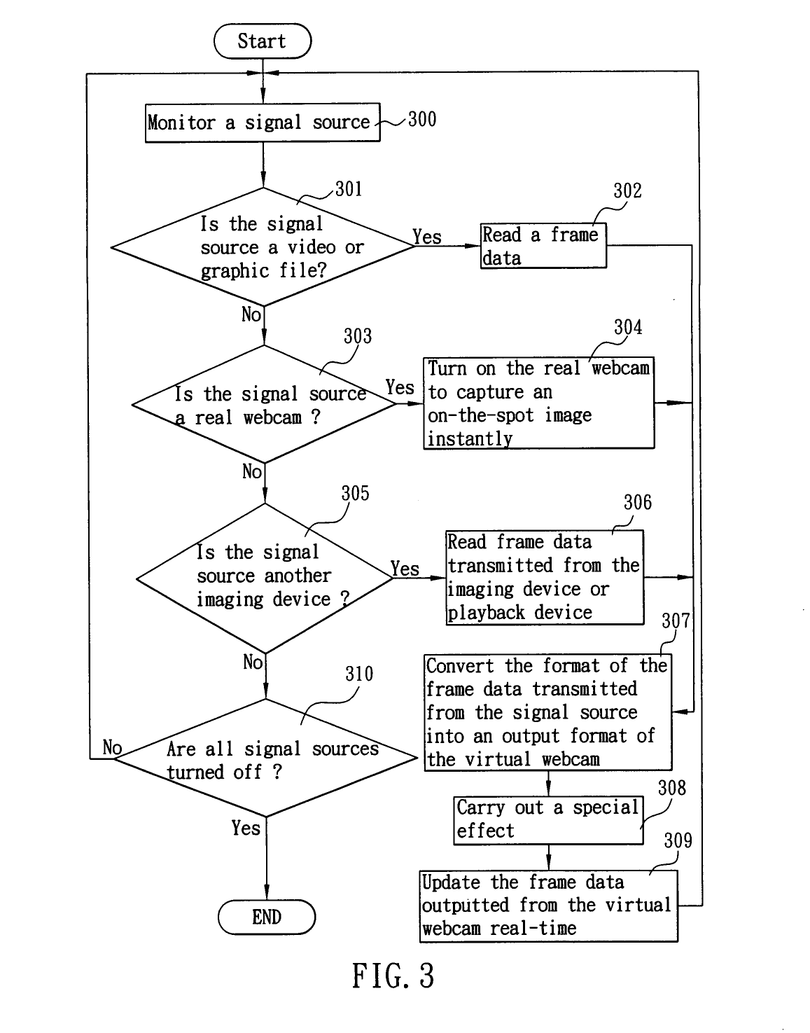

Referring to FIG. 3 for a data processing module 30 of the virtual webcam 10, the data processing module 30 performs a processing procedure comprising the steps of:

Step (300): monitoring the signal source, and receiving a video signal transmitted from a signal source;

Step (301): determining whether or not the signal source is a video or graphic file stored in a computer; if yes, then go to Step (302), or else go to Step (303);

Step (302): downloading the video file or picture stored in the computer, and sequentially reading frame data in the video or graphic file, and decoding the frame data, and continuing Step (307);

Step (303): determining whether or not the signal source is a real webcam; if yes, then go to Step (304), or else go to Step (305);

Step (304): turning on the real webcam to capture an on-the-spot image instantly, and generating frame data, and continuing Step (307);

Step (305): determining whether or not the signal source is another imaging device (such as a digital camera) or a playback device (such as a DV device); if yes, then go to Step (306), or else go to Step (310);

Step (306): turning on the imaging device or playback device, and sequentially reading frame data of the imaging device or playback device, and then continuing Step (307);

Step (307): processing the format of the frame data of the signal source, and converting such format into an output format of the virtual webcam 10 according to the user's setup parameter, and continuing Step (308);

Step (308): carrying out a special effect processing for the frame data outputted by the virtual webcam 10 according to the type of special effect processing set by the user, and continuing Step (309);

Step (309): updating the frame data outputted from the virtual webcam 10 real-time and returning to Step (300); and

Step (310): determining whether or not all signal sources are turned off; if yes, then end the processing procedure of the data processing module 30, or else return to Step (300), and continue the foregoing procedure.

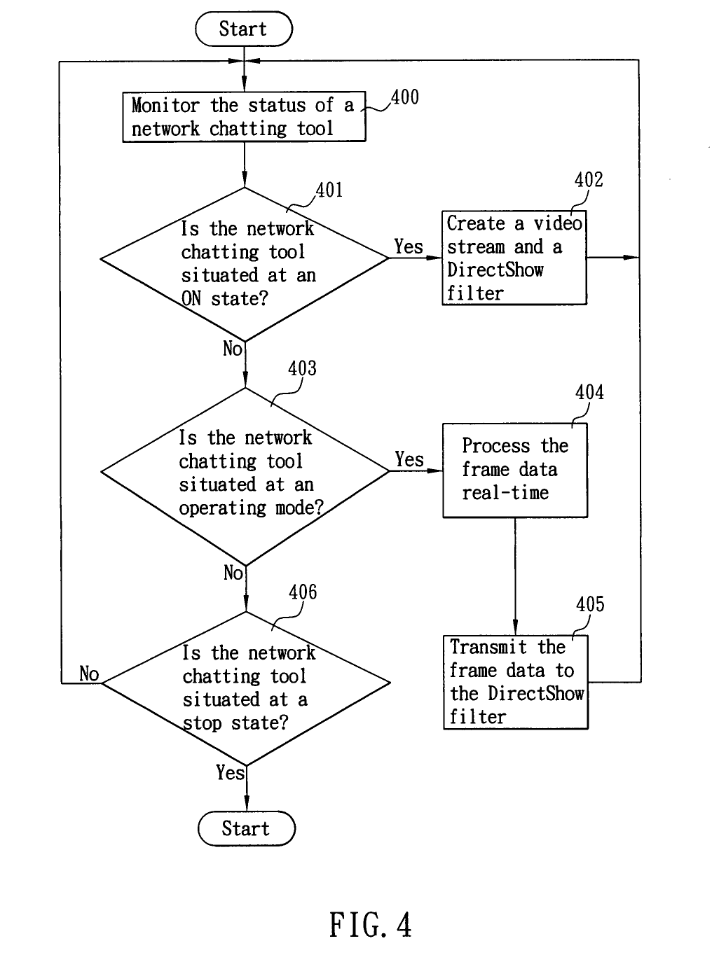

The virtual webcam driver module 40 of the virtual webcam 10 is installed to a computer through an operating system (such as Windows OS) or downloaded from a computer, and the webcam driving module 40 could be a terminate and stay resident program, and its target program is a network chatting tool such as Yahoo Messenger or MSN Messenger. Referring to FIG. 4 for a virtual webcam driver module 40 of the present invention, the virtual webcam driver module 40 performs a processing procedure comprising the steps of:

Step (400): monitoring the status of the network chatting tool of the computer; thus, the ON or OFF state of the network chatting tool directly affects the monitoring result;

Step (401): determining whether or not the network chatting tool is situated at an ON state; if yes, then go to Step (402), or else go to Step (403);

Step (402): creating an element such as a video stream and a DirectShow filter, and then entering into an operating mode, and returning to Step (400);

Step (403): determining whether or not the network chatting tool is situated at an operating mode; if yes, then go to Step (404), or else go to Step (406);

Step (404): processing the frame data real-time, and adjusting the size of frame data according to the user's setting, and converting the format of the frame data to facilitate the use of the network chatting tool;

Step (405): transmitting the processed frame data to an output port of the DirectShow filter, such that the network chatting tool an use the frame data outputted by the DirectShow filter, and returning to Step (400), and continuing the foregoing procedure; and

Step (406): determining whether or not the network chatting tool is situated at a stop or OFF state; if yes, then end the processing procedure of the virtual webcam driver module 40, or else return to Step (400), and continue the foregoing procedure.

In view of the description above, the virtual webcam of the present invention is applied to a computer, and used together with a chatting tool installed on the computer. For computer users who have installed a real webcam regardless of whether or not the image transmission format of the real webcam is compatible with the chatting tool, the virtual webcam of the invention can convert a vide image captured by the real webcam into an image transmission format acceptable to the chatting tool. After the special effect processing of the virtual webcam is performed and provided for the opposite party over the internet through the chatting tool, the invention can effectively avoid disclosing a user's personal chatting location or revealing the user's personal life and privacy. As to computer users who have not installed a real webcam, these users can play a video or graphic file stored in the computer to the opposite party by the virtual webcam through the chatting tool, so that both parties can share the video or graphic files on a video screen to avoid facing the monotonous video screen without any image, and thus the invention can bring more fun to the instant chatting.

While the invention herein disclosed has been described by means of specific embodiments, numerous modifications and variations could be made thereto by those skilled in the art without departing from the scope and spirit of the invention set forth in the claims.

What is claimed is:

1. A virtual webcam, applied to a computer, comprising:
a user interface application module, being a man-machine interactive interface, for completing an information exchange between a computer and a user, such that the user can set up a parameter and a format of a video signal source, select a setup parameter for a special effect processing of a video signal, and select output parameter and format of said virtual webcam through said user interface application module;
a data processing module, for performing a special effect processing for a video signal transmitted from various different signal sources, and including executing different set special effects and transmitting said video signal processed by the special effect processing out; and
a virtual webcam driver module, being a terminate and stay resident program, for receiving a video signal from said data processing module, and outputting said video signal according to an output format of a general webcam to comply with a format requirement of a chatting tool for facilitating the use of said chatting tool and sharing the contents of said video signals with an opposite party over the Internet.

2. The virtual webcam of claim 1, wherein said video signal source has a parameter for specifying a desired video signal source including a graphic file, a video file, a video instantly captured by a real webcam and other imaging device, or playing a video data generated by a playback device.

3. The virtual webcam of claim 2, wherein said special effect processing is set for specifying the type of a special effect including a fun-house mirror, a cartoon style or a mosaic effect to be performed for said video signal.

4. The virtual webcam of claim 3, wherein said user interface application module performs a processing procedure comprising the steps of:
receiving a setup signal inputted by a user through an input device of said computer;
determining whether or not said setup signal selects to set up a video signal source;
determining whether or not said setup signal selects to set up a special effect processing for said video signal;
determining whether or not said setup signal selects to set up said virtual webcam; and
determining whether or not said user confirms the completion of a setup; if yes, then end the processing procedure of said user interface application module, or else return to the foregoing procedure and continue the foregoing determinations.

5. The virtual webcam of claim 4, wherein if said setup signal selects to set up said video signal source, then a parameter and a format of said video signal source will be set up, and the processing procedure will return to the foregoing procedure and continue the foregoing determination.

6. The virtual webcam of claim 4, wherein if said setup signal selects to set up a special effect processing for said video signal, a special effect processing will be set up for said video signal, and the processing procedure returns to the foregoing procedure and continues the foregoing determination.

7. The virtual webcam of claim 4, wherein if said setup signal selects to set up said virtual webcam, the parameter and format outputted by said virtual webcam will be set, and the processing procedure will return to the foregoing procedure and continue the foregoing determination.

8. The virtual webcam of claim 3, wherein said data processing module performs a processing procedure comprising the steps of:
monitoring a signal source, and receiving a video signal transmitted from said signal source;
determining whether or not said signal source is a video or graphic file stored in a computer;
determining whether or not said signal source is a real webcam;
determining whether or not said signal source is another imaging device or playback device; and
determining whether or not all signal sources are turned off, if yes, end the processing procedure of said data processing module, or else return to the foregoing steps and continue the foregoing determination.

9. The virtual webcam of claim 8, wherein if said signal source is a video or graphic file stored in a computer, then said video file or a picture will be downloaded, and frame data in said video or graphic file will be read, and said frame data will be decoded.

10. The virtual webcam of claim 8, wherein if said signal source is a real webcam, said real webcam will be turned on for instantly capturing an on-the-spot image and producing a frame data.

11. The virtual webcam of claim 8, wherein if said signal source is another imaging device or playback device, said imaging device or playback device will be turned on for reading a frame data of said imaging device or said playback device.

12. The virtual webcam of claims 9, further comprising:
processing the format of a frame data transmitted from said signal source, and converting the format of said frame data into an output format of said virtual webcam according to the parameter set by said user;
performing a special effect processing to a frame data outputted by said virtual webcam according to a special effect processing type set by said user; and
updating the frame data outputted from said virtual webcam real-time, and the processing procedure will return to the foregoing procedure and continue the foregoing determination.

13. The virtual webcam of claims 10, further comprising:
processing the format of a frame data transmitted from said signal source, and converting the format of said frame data into an output format of said virtual webcam according to the parameter set by said user;
performing a special effect processing to a frame data outputted by said virtual webcam according to a special effect processing type set by said user; and
updating the frame data outputted from said virtual webcam real-time, and the processing procedure will return to the foregoing procedure and continue the foregoing determination.

14. The virtual webcam of claims 11, further comprising:
processing the format of a frame data transmitted from said signal source, and converting the format of said frame data into an output format of said virtual webcam according to the parameter set by said user;
performing a special effect processing to a frame data outputted by said virtual webcam according to a special effect processing type set by said user; and
updating the frame data outputted from said virtual webcam real-time, and the processing procedure will return to the foregoing procedure and continue the foregoing determination.

15. The virtual webcam of claim 3, wherein said virtual webcam driver module is installed on said computer from an operating system or downloaded from said computer, and said virtual webcam driver module is a terminate and stay resident program, and its target program is a network chatting tool, and said virtual webcam driver module performs a processing procedure comprising the steps of:
monitoring the state of said network chatting tool installed on said computer;
determining whether or not said network chatting tool is situated at an ON state;
determining whether or not said network chatting tool is situated at an operating state; and
determining whether or not said network chatting tool is stopped or situated at an OFF state; if yes, then end the processing procedure of said virtual webcam driver module, or else the foregoing processing procedure returns to the foregoing steps and continues the foregoing determination.

16. The virtual webcam of claim 15, wherein if said network chatting tool is situated at an ON state, an element including a video stream and a DirectShow filter will be created, and the processing procedure will enter into an operating mode, and return to the foregoing steps and continue the foregoing determination.

17. The virtual webcam of claim 15, wherein if said network chatting tool is situated at an operating state, said frame data will be processed real-time, and the size of said frame data will be adjusted according to a user's setting, and the format of said frame data will be converted for facilitating the use of a network chatting tool, and said processed frame data will be transmitted to an output port of said DirectShow filter, and the processing procedure will return to the foregoing steps and continue the foregoing determination.
